(19) United States
(12) Patent Application Publication
(10) Pub. No.: US 2021/0116064 A1
(43) Pub. Date: Apr. 22, 2021

(54) PIPE CONNECTION STRUCTURE

(71) Applicant: TOYODA IRON WORKS CO., LTD., Toyota-shi, Aichi-ken (JP)

(72) Inventors: Hiroshi KURIYAMA, Toyota-shi (JP); Hideaki SAKAI, Toyota-shi (JP); Kunihiro IWATA, Toyota-shi (JP)

(73) Assignee: TOYODA IRON WORKS CO., LTD., Toyota-shi, Aichi-ken (JP)

(21) Appl. No.: 17/054,525

(22) PCT Filed: Apr. 26, 2019
(86) PCT No.: PCT/JP2019/018045

§ 371 Date: Nov. 11, 2020

(30) Foreign Application Priority Data
May 14, 2018 (JP) 2018-093093

(51) Int. Cl. F16L 41/08; F16L 41/02

(52) U.S. Cl. CPC F16L 41/08; F16L 41/021

(57) ABSTRACT

A connecting tube portion protrudes outward from an outer wall of the main pipe and is continuous with the interior of the main pipe. The connecting tube portion has an annular groove, into which the distal end of the branch pipe is fitted, at the distal end. The branch pipe includes an outer circumference seal portion that provides a seal between the outer circumferential surface of the distal end of the branch pipe and the inner surface of the annular groove of the connecting tube portion through contact between the outer circumferential surface and the inner surface. The branch pipe also includes an inner circumference seal portion that provides a seal between the inner circumferential surface of the distal end of the branch pipe and the inner surface of the annular groove of the connecting tube portion through contact between the inner circumferential surface and the inner surface.

### TECHNICAL FIELD

The present invention relates to a pipe connection structure in which a branch pipe is connected to a main pipe so as to branch off from the main pipe.

### BACKGROUND ART

Typical piping through which fluid such as oil flows includes a pipe branch, which has a main pipe and a branch pipe, in a section where fluid is diverted or merged (for example, refer to Patent Document 1). As a structure for connecting a main pipe and a branch pipe to each other, a structure is frequently used in which an end of a pipe is melted and deformed, and the deformed end is connected to another pipe. Such a pipe connection structure achieves a high sealing performance at the connection between the main pipe and the branch pipe.

In the above-described structure, an end of a pipe is melted and deformed when the main pipe and the branch pipe are connected to each other. Thus, unnecessary projections (burrs) are likely to be formed at the connection. Burrs formed inside the pipes can hamper smooth flow of fluid. Further, burrs inside the pipes are difficult to remove.

### PRIOR ART DOCUMENT

### Patent Document

Patent Document 1: Japanese Laid-Open Patent Publication No. 2006-29264

### SUMMARY OF THE INVENTION

### Problems that the Invention is to Solve

It is an objective of the present invention to provide a pipe connection structure that achieves a high sealing performance while preventing burrs from being formed at a connection.

### Means for Solving the Problems

To achieve the foregoing objective and in accordance with a first aspect of the present invention, a pipe connection structure is provided in which a branch pipe is connected to a main pipe so as to branch off from the main pipe. The pipe connection structure includes a connecting tube portion that is integrated with the main pipe so as to protrude outward from an outer wall of the main pipe. An interior of the connecting tube portion is continuous with an interior of the main pipe. A distal end of one of the connecting tube portion and the branch pipe is a receiving portion having an annular groove extending over an entire circumference of the receiving portion. A distal end of the other one of the connecting tube portion and the branch pipe is a fitting portion that is fitted into the groove. The pipe connection structure further includes an outer circumference seal portion and an inner circumference seal portion. The outer circumference seal portion provides a seal between an outer circumferential surface of the distal end of the fitting portion and an inner surface of the groove through contact between the outer circumferential surface and the inner surface. The inner circumference seal portion provides a seal between an inner circumferential surface of the distal end of the fitting portion and the inner surface of the groove through contact between the inner circumferential surface and the inner surface.

### BRIEF DESCRIPTION OF THE DRAWINGS

FIG. 1 is a cross-sectional view of a pipe branch in which a pipe connection structure according to an embodiment is employed.

FIG. 2 is a perspective view of the pipe branch.

FIG. 3 is an exploded perspective view of the pipe branch.

FIG. 4 is a cross-sectional view taken along an axial direction of the main pipe.

FIG. 5 is a side view of the main pipe as viewed in a direction of arrow 5 in FIG. 4.

FIG. 6 is a cross-sectional view of the main pipe taken along line 6-6 in FIG. 4.

FIG. 7 is a cross-sectional view of a branch pipe taken along the axial direction of the main pipe.

FIG. 8 is a side view of the branch pipe as viewed in a direction of arrow 8 in FIG. 7.

FIG. 9 is a cross-sectional view of the branch pipe taken along line 9-9 in FIG. 7.

FIG. 10 is an end view of a connection between the main pipe and the branch pipe.

FIG. 11 is an end view of a pipe branch according to a modification.

FIG. 12 is an end view of a pipe branch according to a modification.

FIG. 13 is an end view of a pipe branch according to a modification.

FIG. 14 is a cross-sectional view of a pipe branch according to a modification.

FIG. 15 is a cross-sectional view of a pipe branch according to a modification.

FIG. 16 is an end view of a pipe branch.

### MODES FOR CARRYING OUT THE INVENTION

A pipe connection structure according to an embodiment will now be described.

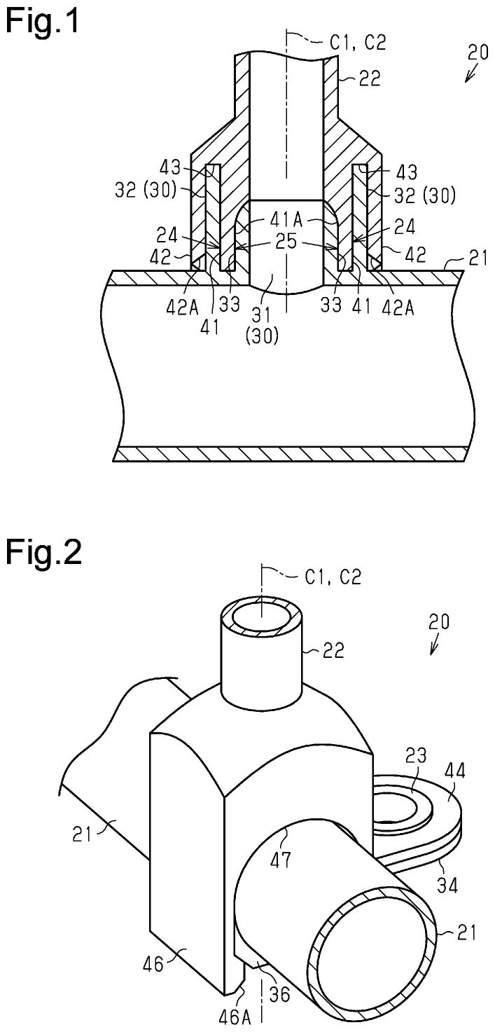

As shown in FIGS. 1 to 3, a pipe branch 20 includes a substantially cylindrical main pipe 21. A branch pipe 22 is connected to the main pipe 21 so as to branch off from the main pipe 21. The main pipe 21 and the branch pipe 22 are made of plastic. The pipe branch 20 is a section of a fluid passage through which fluid (for example, oil) flows, and diverts the fluid flowing in the main pipe 21 to the branch pipe 22. The pipe connection structure of the present embodiment is employed in the pipe branch 20.

The structure of the main pipe 21 will now be described.

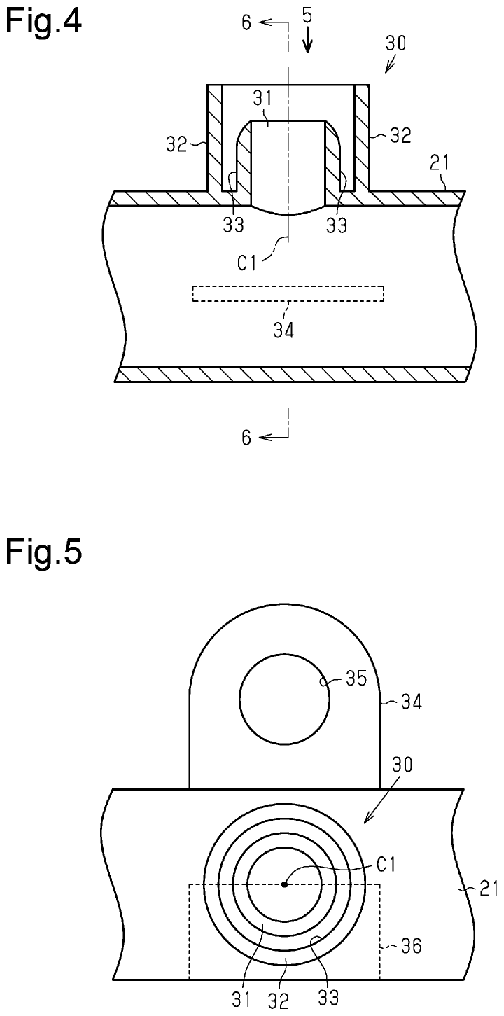

As shown in FIGS. 1 to 6, the main pipe 21 includes a substantially cylindrical connecting tube portion 30. The connecting tube portion 30 is located at a section of the main pipe 21 that is connected to the branch pipe 22. The connecting tube portion 30 protrudes outward (upward as viewed in FIG. 4) from an outer wall of the main pipe 21. The connecting tube portion 30 extends in a direction orthogonal to an axial direction of the main pipe 21 (the lateral direction as viewed in FIG. 4).

The connecting tube portion 30 has a double-wall structure and includes a cylindrical inner tube 31 and a cylindrical outer tube 32. The cylindrical outer tube 32 surrounds the circumference of the inner tube 31. The distal portion of the inner tube 31 has a tapered shape with the thickness decreasing toward the tip (the upper end as viewed in FIG. 4). Accordingly, the distal portion of the inner tube 31 is thinner than the proximal portion. The interior of the inner tube 31 is continuous with the interior of the main pipe 21 and serves as an inner wall of the pipe branch 20. The pipe branch 20 includes the connecting tube portion 30 and the branch pipe 22. The tip of the inner tube 31 is located behind the tip of the outer tube 32 in the protruding direction of the inner tube 31 (upward direction as viewed in FIG. 4). Accordingly, the protruding amount of the inner tube 31 from the outer circumferential surface of the main pipe 21 is smaller than the protruding amount of the outer tube 32. The connecting tube portion 30 has in it an annular groove 33 between the inner tube 31 and the outer tube 32. The annular groove 33 opens at the distal end (receiving portion) of the connecting tube portion 30.

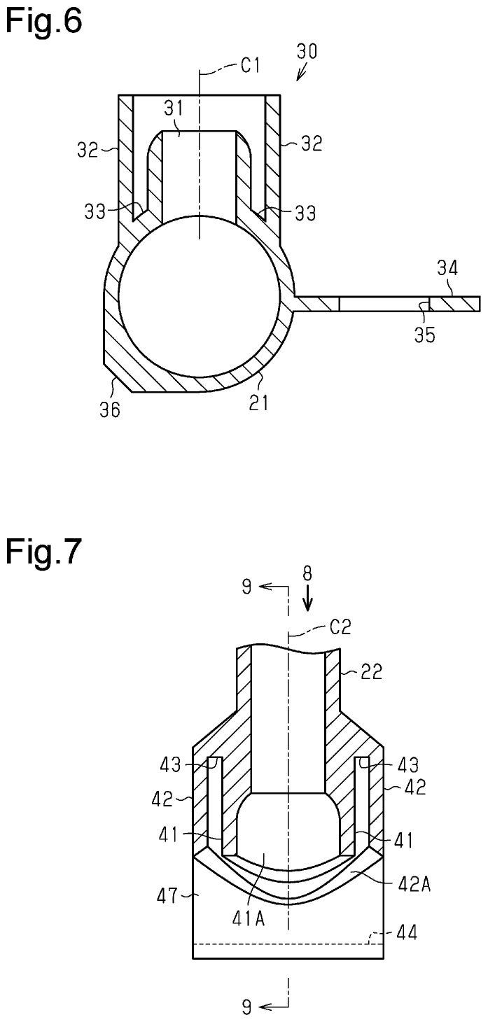

As shown in FIGS. 4 to 6, the main pipe 21 has an engagement plate 34 integrally formed on the outer wall. The engagement plate 34 protrudes in a radial direction of the main pipe 21. The engagement plate 34 is provided at a position that overlaps with the connecting tube portion 30 in the axial direction of the main pipe 21 (the lateral direction as viewed in FIG. 5). The engagement plate 34 is a flat plate that expands in the axial direction and a radial direction (the vertical direction as viewed in FIG. 5) of the main pipe 21. When viewed from an end in the axial direction of the main pipe 21 (in a state shown in FIG. 6), a center line C1 of the connecting tube portion 30 and an outer surface of the engagement plate 34 that extends in a radial direction form an angle of 90 degrees. The engagement plate 34 has a through-hole 35, which extends through the engagement plate 34 in the thickness direction and has a circular cross section.

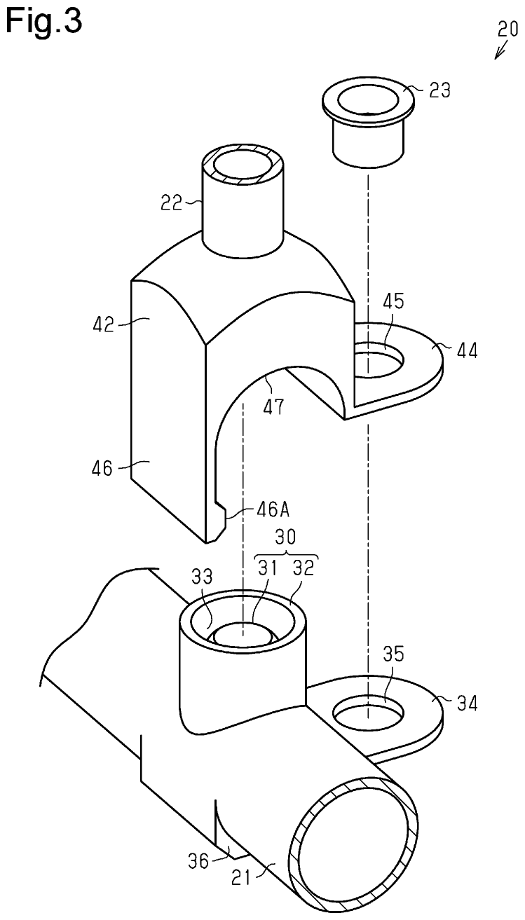

As shown in FIGS. 3, 5, and 6, the main pipe 21 has an engagement corner 36 on the outer wall. The engagement corner 36 protrudes outward. The engagement corner 36 is provided at a position that overlaps with both of the connecting tube portion 30 and the engagement plate 34 in the axial direction of the main pipe 21.

When viewed from an end in the axial direction of the main pipe 21, the engagement corner 36 is located on the opposite side of the center line C1 of the connecting tube portion 30 from the engagement plate 34. When viewed from an end in the axial direction of the main pipe 21, the engagement corner 36 is located on the opposite side of the outer surface of the engagement plate 34 that extends in the radial direction (the upper surface as viewed in FIG. 6) from the connecting tube portion 30. The engagement corner 36 has a shape that is formed by diagonally shaving (chamfering) a right-angle section formed by two tangent planes of the outer circumferential surface of the main pipe 21.

The structure of the branch pipe 22 will now be described.

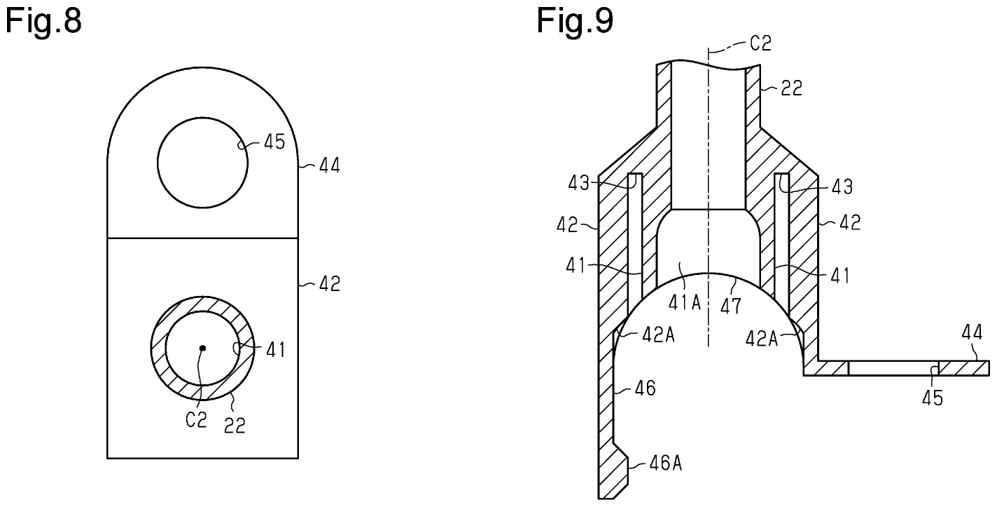

As shown in FIGS. 7 to 9, the distal end of the branch pipe 22 (fitting portion) has a double-wall structure and includes a cylindrical inner tube 41 and an outer tube 42. The outer tube 42 has an inner circumferential surface with a circular cross section and surrounds the circumference of the inner tube 41. The inner tube 41 has an engagement recess 41A at the distal portion of the inner circumferential surface. The engagement recess 41A extends over the entire circumference of the inner tube 41. The size of the engagement recess 41A decreases toward the proximal end. The inner circumferential surface of the engagement recess 41A has substantially the same shape as the outer circumferential surface of the inner tube 31 of the connecting tube portion 30 shown in FIG. 1. A distal portion 42A of the inner circumferential surface of the outer tube 42 is inclined radially outward toward the distal end. The branch pipe 22 has, at the distal end, an annular groove 43 between the inner tube 41 and the outer tube 42.

The branch pipe 22 also has, at the distal end, a connecting recess 47, which extends in the axial direction of the main pipe 21 and has a substantially semi-circular cross section. The inner surface of the connecting recess 47 has substantially the same shape as the outer circumferential surface of the main pipe 21. Therefore, when the branch pipe 22 is attached to the main pipe 21, the inner surface of the connecting recess 47 is arranged along the outer circumferential surface of the main pipe 21 as shown in FIG. 2.

The branch pipe 22 has an engagement plate 44 on the outer wall of the outer tube 42. The engagement plate 44 protrudes outward from the distal end of the outer tube 42. The engagement plate 44 is a flat plate that expands in the axial direction of the connecting recess 47 and the radial direction of the branch pipe 22. When viewed from an end in the axial direction of the connecting recess 47 (in a state shown in FIG. 9), a center line C2 of the branch pipe 22 and an outer surface of the engagement plate 44 that extends in the radial direction of the branch pipe 22 form an angle of 90 degrees. The engagement plate 44 has a circular through-hole 45, which extends through the engagement plate 44 in the thickness direction.

When the branch pipe 22 is attached to the main pipe 21, the outer surface of the engagement plate 34 of the main pipe 21 and the outer surface of the engagement plate 44 of the branch pipe 22 contact each other as shown in FIG. 2. When the branch pipe 22 attached to the main pipe 21 is viewed from an end in the axial direction of the branch pipe 22, the outer shape of the engagement plate 34 is substantially the same as the engagement plate 44. Also, the outer shape of the through-hole 35 is substantially the same as the outer shape of the through-hole 45.

As shown in FIGS. 2 and 3, the engagement plates 34, 44 are engaged with each other by using a swaging metal part 23 (for example, a metal grommet) that is fitted in the through-holes 35, 45. Specifically, an end of the swaging metal part 23 is swaged with the swaging metal part 23 inserted into the through-holes 35, 45. This fixes the main pipe 21 and the branch pipe 22 to each other.

Also, as shown in FIGS. 3 and 9, the branch pipe 22 has an engagement arm 46 on the outer wall. The engagement arm 46 is an end of the outer tube 42 extending in the protruding direction of the outer tube 42. When viewed from an end in the axial direction of the connecting recess 47, the engagement arm 46 is located on the opposite side of the center line C2 of the branch pipe 22 from the engagement plate 44. The engagement arm 46 has an engagement protrusion 46A, which protrudes inward (rightward in FIG. 9). The engagement protrusion 46A has a trapezoidal cross section and extends in the axial direction of the connecting recess 47.

When the branch pipe 22 is attached to the main pipe 21, the engagement protrusion 46A of the engagement arm 46 is hooked from the outer side to the outer surface of the engagement corner 36 as shown in FIG. 2. This fixes the branch pipe 22 to the main pipe 21.

An operation of mounting the branch pipe 22 to the main pipe 21 will now be described.

First, as shown in FIGS. 2 and 3, the distal end of the branch pipe 22 is fitted into the connecting tube portion 30 of the main pipe 21 such that the outer circumferential surface of the main pipe 21 is fitted to the connecting recess 47 of the branch pipe 22. As a result, the distal end of the inner tube 41 of the branch pipe 22 is inserted into the annular groove 33 between the outer tube 32 and the inner tube 31 of the connecting tube portion 30 as shown in FIG. 1. At this time, the outer tube 32 of the connecting tube portion 30 is inserted into the annular groove 43 between the inner tube 41 and the outer tube 42 of the branch pipe 22.

The distal portion 42A of the inner circumferential surface of the outer tube 42 of the branch pipe 22 is tapered. When the distal end of the connecting tube portion 30 and the distal end of the branch pipe 22 are mated with each other, the distal end of the branch pipe 22 is guided to a proper position by its tapered shape, that is, to a position at which the center line C1 of the connecting tube portion 30 and the center line C2 of the branch pipe 22 match each other. Thus, the distal end of the branch pipe 22 is easily fitted into the connecting tube portion 30.

During the process in which the distal end of the branch pipe 22 is fitted to the connecting tube portion 30 as shown in FIGS. 2 and 3, the engagement arm 46 is elastically deformed outward. After going over the main pipe 21 and the engagement corner 36, the engagement arm 46 returns to the state prior to the deformation. As a result, the engagement protrusion 46A of the engagement arm 46 is hooked from the outer side to the engagement corner 36 of the main pipe 21. In this manner, the branch pipe 22 is fixed to the main pipe 21 through engagement between the engagement corner 36, which is a first engagement portion integrated with the outside of the main pipe 21, and the engagement arm 46, which is a second engagement portion integrated with the outside of the branch pipe 22.

In the state shown in FIG. 2, the outer surface of the engagement plate 34 of the main pipe 21 and the outer surface of the engagement plate 44 of the branch pipe 22 contact each other. In this state, the engagement plates 34, 44 are engaged with each other by using the swaging metal part 23, which is attached to the through-hole 35 of the engagement plate 34 of the main pipe 21 and the through-hole 45 of the engagement plate 44 of the branch pipe 22. In this manner, the branch pipe 22 is fixed to the main pipe 21 by engaging the engagement plate 34, which serves as the first engagement portion, and the engagement plate 44, which serves as the second engagement portion, with the swaging metal part 23.

Operational advantages of pipe branch 20 of the present embodiment will now be described.

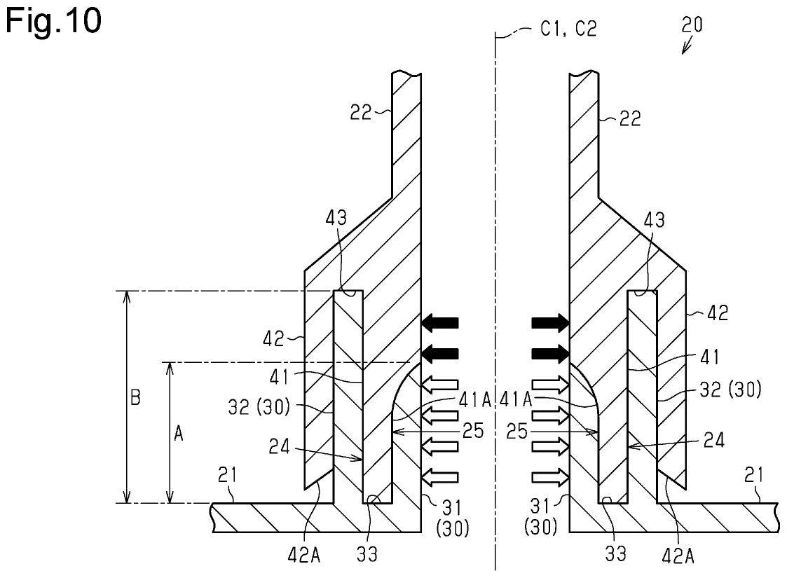

(1) As shown in FIG. 10, in the pipe branch 20, the distal end of the inner tube 41 of the branch pipe 22 is fitted into the annular groove 33 between the inner tube 31 and the outer tube 32 at the distal end of the connecting tube portion 30. As a result, the outer circumferential surface of the inner tube 41 of the branch pipe 22 and the inner circumferential surface of the inner tube 31 of the connecting tube portion 30 contact each other to provide an outer circumference seal portion 24 at the connection between the connecting tube portion 30 and the branch pipe 22 inside the pipe branch 20. The outer circumference seal portion 24 provides a seal between the outer circumferential surface and the inner circumferential surface. Also, the inner circumferential surface of the outer tube 42 of the branch pipe 22 and the outer circumferential surface of the inner tube 31 of the connecting tube portion 30 contact each other to provide an inner circumference seal portion 25 at the connection between the connecting tube portion 30 and the branch pipe 22 inside the pipe branch 20. The inner circumference seal portion 25 provides a seal between the inner circumferential surface and the outer circumferential surface.

The surfaces of the connecting tube portion 30 and the branch pipe 22 that face each other do not have simple tubular shapes or flat shapes, but have complicated shapes with the outer circumference seal portion 24 and the inner circumference seal portion 25. This restricts leakage of fluid through the clearance between the connecting tube portion 30 and the branch pipe 22. This improves the sealing performance at the connection between the connecting tube portion 30 and the branch pipe 22.

(2) When fluid flows through the pipe branch 20, the fluid pressure inside the pipe branch 20 pushes the inner circumferential surface of the inner tube 31 of the connecting tube portion 30 in a direction indicated by the blank arrows in FIG. 10. This elastically deforms the inner tube 31 of the connecting tube portion 30 radially outward, so that the inner tube 31 is pressed against the inner circumferential surface of the inner tube 41 of the branch pipe 22. This increases the contact surface pressure between the outer circumferential surface of the inner tube 31 of the connecting tube portion 30 and the inner circumferential surface of the inner tube 41 of the branch pipe 22. Therefore, the present embodiment improves the sealing performance of the inner circumference seal portion 25, which functions through contact between the outer circumferential surface of the inner tube 31 of the connecting tube portion 30 and the inner circumferential surface of the inner tube 41 of the branch pipe 22.

(3) The distal portion of the inner tube 31 of the connecting tube portion 30 is thinner than the proximal portion. Thus, the distal portion of the inner tube 31 is easily elastically deformed radially outward by the internal pressure of the pipe branch 20. This structure readily increases the contact surface pressure between the outer circumferential surface of the inner tube 31 of the connecting tube portion 30 and the inner circumferential surface of the inner tube 41 of the branch pipe 22. Accordingly, the sealing performance of the inner circumference seal portion 25 is effectively increased.

(4) The protruding amount of the inner tube 31 of the connecting tube portion 30 (represented by A in FIG. 10) from the outer circumferential surface of the main pipe 21 is smaller than the protruding amount of the outer tube 32 of the connecting tube portion 30 (represented by B in FIG. 10). The inner circumferential surface of the inner tube 41 of the branch pipe 22 is the inner wall surface of the pipe branch 20 in the vicinity of the distal end of the outer tube 32 of the connecting tube portion 30. Thus, the fluid pressure inside the branch pipe 22 pushes the inner circumferential surface of the inner tube 41 of the branch pipe 22 in a direction indicated by the solid arrows in FIG. 10. This elastically deforms the inner tube 41 radially outward, so that the inner tube 41 is pressed against the inner circumferential surface of the outer tube 32 of the connecting tube portion 30. This increases the contact surface pressure between the inner circumferential surface of the outer tube 32 of the connecting tube portion 30 and the outer circumferential surface of the inner tube 41 of the branch pipe 22. Therefore, the present embodiment improves the sealing performance of the outer circumference seal portion 24, which functions through contact between the inner circumferential surface of the outer tube 32 of the connecting tube portion 30 and the outer circumferential surface of the inner tube 41 of the branch pipe 22.

(5) The distal end of the inner tube 41 of the branch pipe 22 being fitted into the annular groove 33 of the connecting tube portion 30 increases the sealing performance at the connection between the connecting tube portion 30 of the main pipe 21 and the branch pipe 22. This eliminates the need for the structure in which ends of the connecting tube portion 30 and the branch pipe 22 are integrated by being melted and deformed. Therefore, formation of burrs is prevented at the connection between the connecting tube portion 30 and the branch pipe 22.

The above-described embodiment may be modified as follows.

The through-holes 35, 45 of the engagement plates 34, 44 do not need to have a circular cross section, but may have an oval cross section. The sizes of the through-holes 35, 45 of the engagement plates 34, 44 may be slightly different. This configuration allows the engagement plates 34, 44 to be easily fixed to each other by using the swaging metal part 23 attached to the through-holes 35, 45, while allowing for misalignment between the relative positions of the through-holes 35, 45 due to, for example, manufacturing tolerances.

The thickness of the distal portion of the inner tube 31 of the connecting tube portion 30 may be the same as or greater than the thickness of the proximal portion.

The shape of the connecting tube portion 30 may be changed such that the tip of the inner tube 31 is located in front of the tip of the outer tube 32 in the protruding direction. Alternatively, the shape of the connecting tube portion 30 may be changed such that the tip of the inner tube 31 is located at the same position as the tip of the outer tube 32 in the protruding direction.

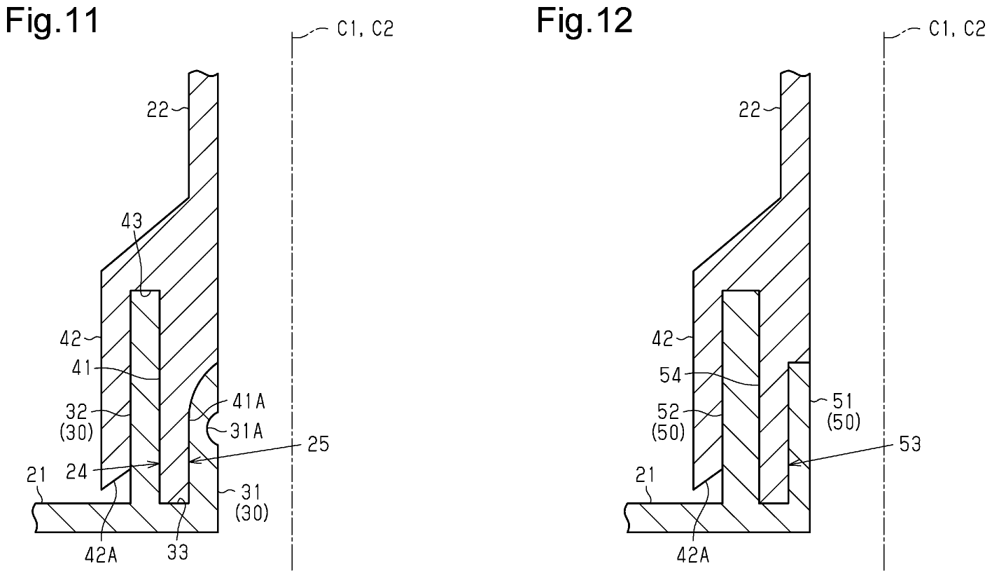

As shown in FIG. 11, the inner tube 31 of the connecting tube portion 30 may have a recess 31A, which is recessed radially outward, in the inner circumferential surface. This configuration increases the surface area of the section of the inner circumferential surface of the inner tube 31 on which the fluid pressure acts, as compared to the structure without the recess 31A. Accordingly, under the condition in which the fluid pressure is constant, the force of the fluid pressure by which the inner tube 31 is pushed radially outward is increased. This effectively increases the sealing performance of the inner circumference seal portion 25, which provides a seal between the inner circumferential surface of the inner tube 41 of the branch pipe 22 and the outer circumferential surface of the inner tube 31 of the connecting tube portion 30.

As shown in FIG. 12, the thickness of an inner tube 51 of a connecting tube portion 50 may be smaller than the thickness of an outer tube 52. This structure allows the inner tube 51 of the connecting tube portion 50 to be easily elastically deformed, so as to increase the sealing performance of an inner circumference seal portion 53. The structure also increases the stiffness of the outer tube 52 of the connecting tube portion 50. This allows the outer tube 52 to reliably support, from the radially outer side, the distal end of an inner tube 54 of the branch pipe 22 and the inner tube 51 of the connecting tube portion 50.

A protrusion may be provided on one of the surface of the connecting tube portion 30 and the surface of the distal end of the branch pipe 22 that face each other in a direction intersecting with the axial direction of the branch pipe 22, and a recess may be provided in the other surface. The protrusion and the recess may be engaged with each other when the distal end of the inner tube 41 of the branch pipe 22 is fitted into the annular groove 33 of the connecting tube portion 30.

This configuration causes the protrusion and the recess to be engaged with each other in a section in which the surface of the connecting tube portion 30 and the surface of the branch pipe 22 face each other in a direction intersecting with the axial direction of the branch pipe 22. This restricts relative movement between the branch pipe 22 and the connecting tube portion 30 in the axial direction of the branch pipe 22. That is, the branch pipe 22 is difficult to pull out of the connecting tube portion 30. Thus, the branch pipe 22 resists removal from the main pipe 21 even if a force acting to pull out the branch pipe 22 from the connecting tube portion 30 of the main pipe 21 is applied.

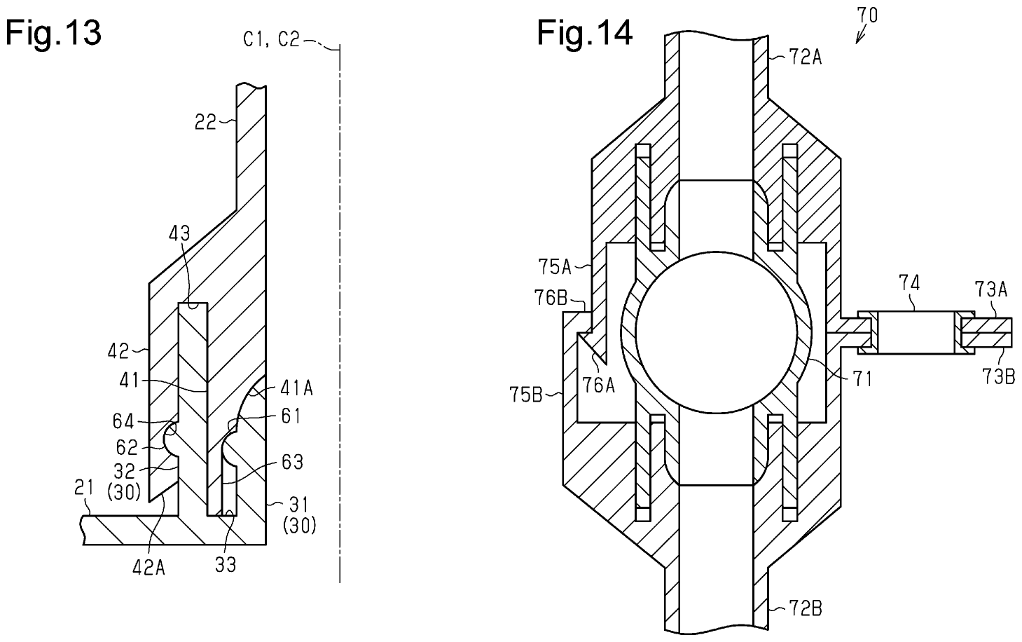

In the example of FIG. 13, a first protrusion 61 is provided on the outer circumferential surface of the inner tube 31 of the connecting tube portion 30, and a second protrusion 62 is provided on the outer circumferential surface of the outer tube 32. Also, a first recess 63 is provided in the inner circumferential surface of the inner tube 41 of the branch pipe 22, and a second recess 64 is provided in the inner circumferential surface of the outer tube 42. As shown in FIG. 13, the distal end of the inner tube 41 of the branch pipe 22 is fitted into the annular groove 33 at the distal end of the connecting tube portion 30. In this state, the first protrusion 61 and the first recess 63 are engaged with each other, and the second protrusion 62 and the second recess 64 are engaged with each other.

It is possible to change the structure that fixes the main pipe 21 and the branch pipe 22 to each other while connecting the pipes 21, 22 to each other. For example, as the means of fixing the main pipe 21 and the branch pipe 22 to each other, it is possible to use only the structure that achieves engagement by means of the swaging metal part 23 or the structure that causes the engagement arm 46 and the engagement corner 36 to be engaged with each other. Alternatively, as in the case of a pipe branch 70 shown in FIG. 14, a main pipe 71 and branch pipes 72A, 72B may be fixed to each other. The pipe branch 70 has a structure in which the two branch pipes 72A, 72B are connected to the single main pipe 71. Engagement plates 73A, 73B that are integrated with the branch pipes 72A, 72B, respectively, are engaged with each other by means of a swaging metal part 74. Also, engagement protrusions 76A, 76B at the distal ends of engagement arms 75A, 75B, which are integrated with the branch pipes 72A, 72B, respectively, are hooked to each other.

A configuration may be employed in which the distal end of an inner tube of a connecting tube portion is fitted into an annular groove between an inner tube and an outer tube at the distal end of a branch pipe in a structure in which the inner tube of the branch pipe provides the inner wall of the pipe branch. In this configuration, the outer circumferential surface of the inner tube of the branch pipe and the inner circumferential surface of the inner tube of the connecting tube portion provide an inner circumference seal portion, and the inner circumferential surface of the outer tube of the branch pipe and the outer circumferential surface of the inner tube of the connecting tube portion provide an outer circumference seal portion.

The distal portion of a connecting tube portion or a branch pipe may have a multiple-wall structure having three or more walls. The distal portion of one of a connecting tube portion and a branch pipe may have a single-wall structure.

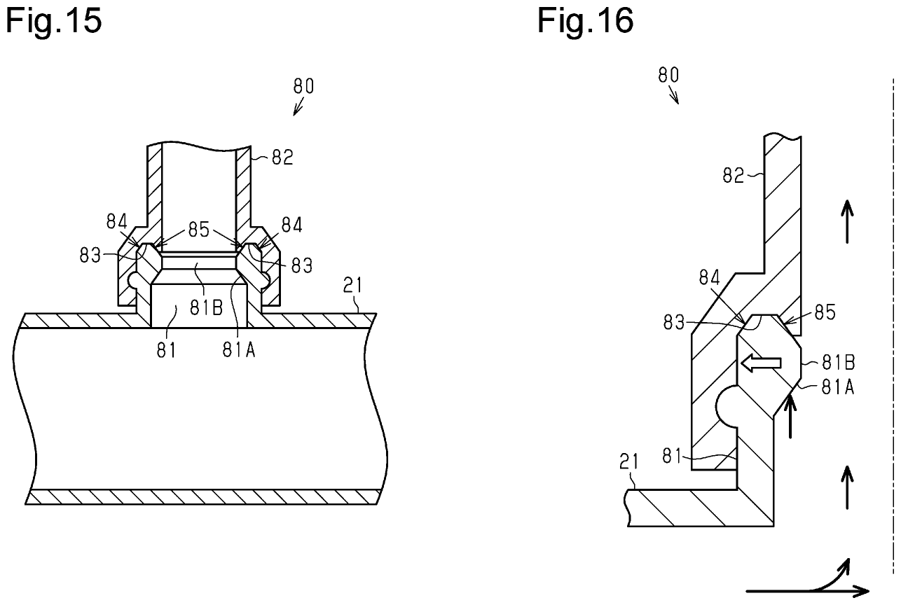

The configuration shown in FIGS. 15 and 16 may be employed. In this configuration, a connecting tube portion 81 and a branch pipe 82 each have a single-wall structure. The branch pipe 82 has an annular groove 83, which extends over the entire circumference of the distal end of the branch pipe 82. The distal end of the connecting tube portion 81 is fitted into the annular groove 83 at the distal end of the branch pipe 82.

With this configuration, operational advantages similar to those of the above-described embodiments are achieved. That is, a pipe branch 80 incorporates an outer circumference seal portion 84, which provides a seal between the outer circumferential surface of the distal end of the connecting tube portion 81 and the inner surface of the annular groove 83 of the branch pipe 82. Also, the pipe branch 80 incorporates an inner circumference seal portion 85, which provides a seal between the inner circumferential surface of the distal end of the connecting tube portion 81 and the inner surface of the annular groove 83 of the branch pipe 82. The pipe branch 80 restricts leakage of fluid through the clearance between the connecting tube portion 81 and the branch pipe 82. This improves the sealing performance at the connection between the connecting tube portion 81 and the branch pipe 82. Further, the internal pressure of the pipe branch 80 presses the radially inner wall of the annular groove 83 of the branch pipe 82 against the inner circumferential surface of the distal end of the connecting tube portion 81. This increases the contact surface pressure between the inner surface of the annular groove 83 and the inner circumferential surface of the distal end of the connecting tube portion 81. Accordingly, the sealing performance of the inner circumference seal portion 85 is increased.

In this manner, the distal end of the connecting tube portion 81 being fitted into the annular groove 83 of the distal end of the branch pipe 82 increases the sealing performance at the connection between the branch pipe 82 and the connecting tube portion 81. This eliminates the need for the structure in which ends of the connecting tube portion 81 and the branch pipe 82 are integrated by being melted and deformed. Therefore, formation of burrs is prevented at the connection between the connecting tube portion 81 and the branch pipe 82.

As shown in FIGS. 15 and 16, the pipe branch 80 may have an inclined surface 81A in a section of the inner circumferential surface (in this example, the inner surface of the connecting tube portion 81). The inclined surface 81A is inclined radially inward toward the downstream end in the flowing direction of fluid. In this example, the connecting tube portion 81 has a protrusion 81B at the inner circumferential surface of the distal end. The protrusion 81B has a trapezoidal cross section and extends over the entire circumference. The protrusion 81B has the inclined surface 81A on the upstream side in the flow direction of fluid. The inclined surface 81A is inclined inward toward the downstream end. With this configuration, when the flow of fluid in the pipe branch 80 strikes the inclined surface 81A as indicated by thick-lined arrows in FIG. 16, the flow pressure of the fluid presses the inclined surface 81A. Accordingly, as indicated by the outline arrow in FIG. 16, the distal portion of the connecting tube portion 81 is pressed radially outward. This presses the outer circumferential surface of the distal end of the connecting tube portion 81 against the inner surface of the annular groove 83 at the distal end of the branch pipe 82, thereby increasing the sealing performance of the outer circumference seal portion 84.

The branch pipe 82 may have an inclined surface on the inner circumferential surface. In this configuration, the flow pressure of fluid presses the inner circumferential surface of the branch pipe 82 radially outward. This presses the wall on the radially inner side of the annular groove 83 of the branch pipe 82 against the outer circumferential surface of the distal end of the connecting tube portion 81, thereby increasing the sealing performance of the inner circumference seal portion 85.

1. A pipe connection structure, in which a branch pipe is connected to a main pipe so as to branch off from the main pipe, the pipe connection structure comprising a connecting tube portion that is integrated with the main pipe so as to protrude outward from an outer wall of the main pipe, an interior of the connecting tube portion being continuous with an interior of the main pipe, wherein
a distal end of one of the connecting tube portion and the branch pipe is a receiving portion having an annular groove extending over an entire circumference of the receiving portion, and
a distal end of the other one of the connecting tube portion and the branch pipe is a fitting portion that is fitted into the groove,
the pipe connection structure further comprising:
an outer circumference seal portion that provides a seal between an outer circumferential surface of the distal end of the fitting portion and an inner surface of the groove through contact between the outer circumferential surface and the inner surface; and
an inner circumference seal portion that provides a seal between an inner circumferential surface of the distal end of the fitting portion and the inner surface of the groove through contact between the inner circumferential surface and the inner surface.

2. The pipe connection structure according to claim 1, wherein
the distal end of the receiving portion includes a pipe having a multiple-wall structure that includes an inner tube and an outer tube, the inner tube including an inner wall of the receiving portion, and the outer tube surrounding a circumference of the inner tube, and
the annular groove is a clearance between the inner tube and the outer tube.

3. The pipe connection structure according to claim 2, wherein a tip of the inner tube is located behind a tip of the outer tube in a protruding direction of the pipe having a multiple-wall structure.

4. The pipe connection structure according to claim 2, wherein
the inner tube includes a distal portion and a proximal portion, and
the distal portion is thinner than the proximal portion.

5. The pipe connection structure according to claim 2, wherein an inner circumferential surface of the inner tube includes a recess that is recessed radially outward.

6. The pipe connection structure according to claim 2, wherein a thickness of the inner tube is smaller than a thickness of the outer tube.

7. The pipe connection structure according to claim 1, wherein
the main pipe and the branch pipe provide a fluid passage through which fluid flows, and
at a connection between the connecting tube portion and the branch pipe, at least a section of an inner circumferential surface of the fluid passage is an inclined surface that is inclined radially inward toward a downstream end in a flowing direction of the fluid.

8. The pipe connection structure according to claim 1, wherein
a protrusion is provided on one of a surface of the connecting tube portion and a surface of the branch pipe that face each other in a direction intersecting with an axial direction of the branch pipe, and a recess is provided in the other surface, and
the protrusion and the recess are engaged with each other.

9. The pipe connection structure according to claim 1, further comprising:
a first engagement portion that is integrated with an outside of the main pipe, and
a second engagement portion that is integrated with an outside of the branch pipe,
wherein the main pipe and the branch pipe are integrated with and fixed to each other through engagement of the first engagement portion and the second engagement portion.
